(19) United States
(12) Patent Application Publication
(10) Pub. No.: US 2024/0308117 A1
(43) Pub. Date: Sep. 19, 2024

(54) SELF-ALIGNING CORE BODY FOR FORMING GOLF BALL SUB-ASSEMBLY WITH FOAMED CASING LAYER

(71) Applicant: Acushnet Company, Fairhaven, MA (US)

(72) Inventors: Shawn Ricci, New Bedford, MA (US); Mark L. Binette, Mattapoisett, MA (US)

(73) Assignee: Acushnet Company, Fairhaven, MA (US)

(21) Appl. No.: 18/182,450

(22) Filed: Mar. 13, 2023

(51) Int. Cl. B29C 44/12; B32B 5/20; B32B 25/04

(52) U.S. Cl. CPC B29C 44/1266; B29C 44/129; B32B 5/20; B32B 25/045; B29L 2031/546; B32B 2266/0278

(57) ABSTRACT

A golf ball sub-assembly is provided that is formed from a core body and a foamed casing layer. The core body has a non-spherical profile due to the presence of centering elements, which can be provided in the form of protrusions or other types of structures on the outer surface of the core body. A foamed material is used for the casing layer. The core body can be plunged into a casting mold including the foamed material prior to the foamed material reaching a viscosity level that is typically required for the core body to be properly situated within the casting mold. A method of forming a golf ball using a core body having protrusions is also disclosed herein. The protrusions promote concentricity and therefore the method does not require targeting a specific viscosity of a foamed casing material when plunging the core body within the casting mold.

### FIELD OF THE INVENTION

This disclosure generally relates to a golf ball sub-assembly, and more particularly relates to a self-aligning core body for use in golf balls including foamed layer constructions.

### BACKGROUND OF THE INVENTION

Multi-layer golf balls are well known. However, it is also well known that various issues can arise when forming a casing layer around a core body of the golf ball. For example, sufficient adhesion between a core body and casing layer can be challenging. Another issue that arises during formation of a casing layer around a core body involves determining when to plunge the core body into a foamed casing layer material that has been deposited on an inner surface of a casting mold.

Using conventional techniques, active monitoring of the curing or foaming of the foamed casing layer material is required to determine when the material reaches a target curing state. This type of active monitoring can also be required for non-foamed casing materials as well. The target curing state can be based on the viscosity of the foamed casing layer material. There are competing factors related to when to plunge the core body due to the nature of the foamed casing layer material. For example, foaming of the foamed casing layer material can cause displacement of the core body if plunging is performed too late. The golf ball sub-assembly will sink if the foamed casing layer material is not viscous enough to support the weight of the golf ball sub-assembly. Additionally, it is critical that the core body is not plunged prematurely into the foamed casing layer material such that the viscosity of the foamed casing layer material has not reached a sufficient viscosity.

It would be desirable to provide an improved arrangement for a core body of a golf ball sub-assembly that avoids the issues associated with plunging the core body within a prerequisite timeframe, and also ensures that the core body is reliably centered relative to a casting mold or other molding component.

### SUMMARY OF THE INVENTION

Various features are disclosed herein that provide a reliable configuration for positioning a core body or golf ball sub-assembly when applying a casing layer. The casing layer can be formed from a foamed or foaming material and therefore the relative timing of the formation steps and the positioning of the components of the golf ball sub-assembly relative to each other is important. As used herein, the term golf ball core can broadly refer to both a core body (i.e., the innermost portion of a golf ball), as well as a casing layer or casing (which is also referred to as a mantle of a golf ball). In one aspect, the term golf ball sub-assembly can also be used to refer to a golf ball core and/or a golf ball core in addition to a casing layer. The golf ball core or sub-assembly can include a single layer or multiple layers. One of ordinary skill in the art understands that a commercially available golf ball also typically includes a cover around the golf ball sub-assembly. The concepts disclosed herein could also be adapted or applied to the formation process of adding a cover layer to a golf ball sub-assembly.

A method of forming a golf ball sub-assembly is disclosed herein. The method comprises (i) providing a core body comprising a plurality of protrusions that project from an outer surface of the core body; (ii) applying a foamed casing material to an interior surface of at least one first casting mold; (iii) plunging the core body into the at least one first casting mold including the foamed casing material such that at least a subset of the plurality of protrusions contacts the interior surface of the at least one first casting mold to center the core body relative to the at least one first casting mold; and (iv) curing the foamed casing material such that the foamed casing material fills a void defined between the core body and the at least one first casting mold. Once the foamed casing material is cured, the golf ball sub-assembly (i.e., core body and foamed casing layer) can be removed from the casting mold.

In one aspect, the method further comprises applying an adhesion promoting treatment to the core body prior to plunging the core body. The method can comprise applying a silane solution to the core body prior to plunging. One of ordinary skill in the art would understand that various other treatments could be applied to the core body to promote adhesion between the foamed casing material and the core body. Grinding or other mechanically based adhesion promoting techniques are avoided due to the presence of the protrusions. In another aspect, mechanical grinding techniques may be used so long as the techniques do not interfere with or remove the protrusions.

The method can further comprise engaging the at least one first casting mold with at least one second casting mold to partially define the void prior to step (iv). The foamed casing material can be configured to also fill portions of the void defined between the core body and the at least one second casting mold. The method can further comprise applying the foamed casing material to an interior surface of at least one second casting mold prior to engaging the at least one first casting mold with the at least one second casting mold. Stated differently, the present disclosure can be used for casting methods that involve both single shot (i.e., applying foamed casing material to a single casting mold) and double shot (i.e., applying foamed casing material to both casting mold halves) casting techniques.

The core body can have a non-spherical profile, in one aspect. The core body can have a symmetrical profile, in one aspect. In another aspect, the core body has a lattice profile, and the foamed casing material is configured to permeate cavities of the lattice profile.

The outer surface of the core body can have a primary outer diameter of 1.460 inches-1.590 inches. The core body can have a secondary outer diameter in regions of the plurality of protrusions, and the secondary outer diameter can be 1.510 inches-1.640 inches.

The plurality of protrusions can cover 1%-10% of an outer surface area of the core body, in one aspect. The plurality of protrusions can cover less than 5% of an outer surface area of the core body, in one aspect.

In one aspect, the core body is plunged no later than 30 seconds after applying a foamed casing material to an interior surface of at least one first casting mold. In one aspect, the core body can be plunged immediately after the foamed casing material is deposited.

The foamed casing material can be a polyurethane foam, in one aspect. The polyurethane foam can have a viscosity of 5,000 cp-50,000 cp when the core body is plunged. The polyurethane foam is configured to expand or foam while it cures, i.e., during step (iv).

According to another method, the method of forming a golf ball sub-assembly can comprise: (i) forming a plurality of protrusions on a core body such that the plurality of protrusions project from an outer surface of the core body; (ii) depositing a foamed casing material to an interior surface of at least one first casting mold; (iii) plunging the core body into the at least one first casting mold including the foamed casing material such that at least a subset of the plurality of protrusions contacts the interior surface of the at least one first casting mold to center the core body relative to the at least one first casting mold; (iv) engaging the at least one first casting mold with at least one second casting mold to form a molding assembly that defines a void between the core body, the at least one first casting mold, and the at least one second casting mold; and (v) curing the foamed casing material such that the foamed casing material expands and fills the void to form a casing layer.

According to another method disclosed herein, the method of forming a golf ball sub-assembly can comprise: (i) depositing a foamed casing material on an interior surface of at least one first casting mold. The foamed casing material can be formed from polyurethane foam, for example. The method can include (ii) plunging a core body including plurality of protrusions into the at least one first casting mold including the foamed casing material such that at least a subset of the plurality of protrusions contacts the interior surface of the at least one first casting mold to center the core body relative to the at least one first casting mold. Plunging the core body can occur no later than 30 seconds after depositing the foamed casing material on the interior surface of the at least one first casting mold, and while the polyurethane foam has a viscosity of 5,000 cp-50,000 cp. The method further comprises (iii) engaging the at least one first casting mold with at least one second casting mold to form a molding assembly that defines a void between the core body, the at least one first casting mold, and the at least one second casting mold. Next, the method comprises (iv) curing the foamed casing material such that the foamed casing material expands and fills the void to form a casing layer for the golf ball core.

Additional aspects and features of forming a self-aligning golf ball core are disclosed herein.

### BRIEF DESCRIPTION OF THE DRAWINGS

Further features and advantages of the invention can be ascertained from the following detailed description that is provided in connection with the drawings described below:

FIG. 1A is a cross-sectional view of a partial assembly illustrating depositing foamed casing material on a first casting mold.

FIG. 1B is a cross-sectional view of a core body of a golf ball arranged within a first casting mold according to one aspect.

FIG. 1C is a cross-sectional view of the molding assembly with a core body of a golf ball arranged between a first and second casting mold according to one aspect.

FIG. 1D is a cross-sectional view of a golf ball sub-assembly according to one aspect.

FIG. 2 is a flow chart of one method for forming a golf ball sub-assembly.

FIG. 3 is a flow chart of another method for forming a golf ball sub-assembly.

FIG. 4 is a flow chart of another method for forming a golf ball sub-assembly.

FIG. 5 is a side view of a golf ball sub-assembly according to another aspect.

FIG. 6 is a magnified view of area “A” from FIG. 1D.

### DETAILED DESCRIPTION OF THE INVENTION

According to disclosed embodiments, a self-centering or self-aligning core body for a golf ball sub-assembly, and method of forming a golf ball sub-assembly is provided. In one aspect, the core body is modified to include positioning elements or self-aligning or self-centering elements. These elements can be formed as protrusions, bumps, protuberances, projections, or other shape on the outer surface of the core body. During plunging, these elements ensure that the core body is supported relative to a molding component, and generally positioned in a center, concentric, or aligned orientation relative to the molding component. A foaming or foamed casing layer material then simultaneously cures and foams around the core body. Based on the positioning elements centering the core body in the molding components, there is improved concentricity between the cured casing layer material and the core body.

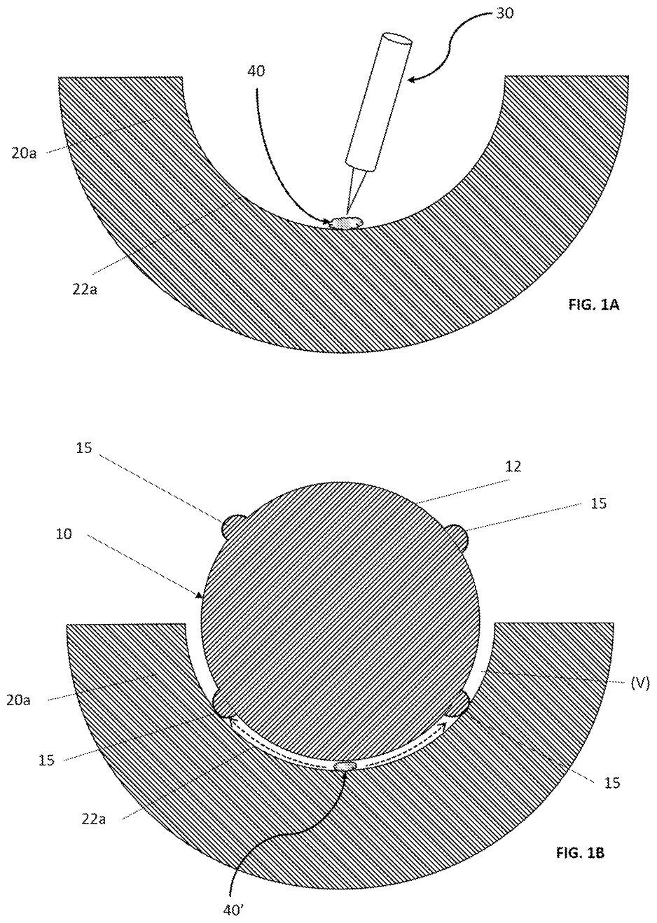

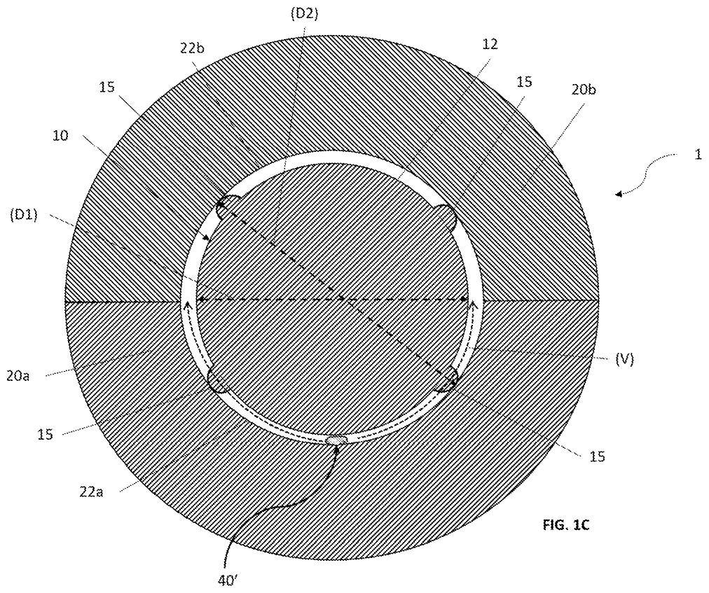

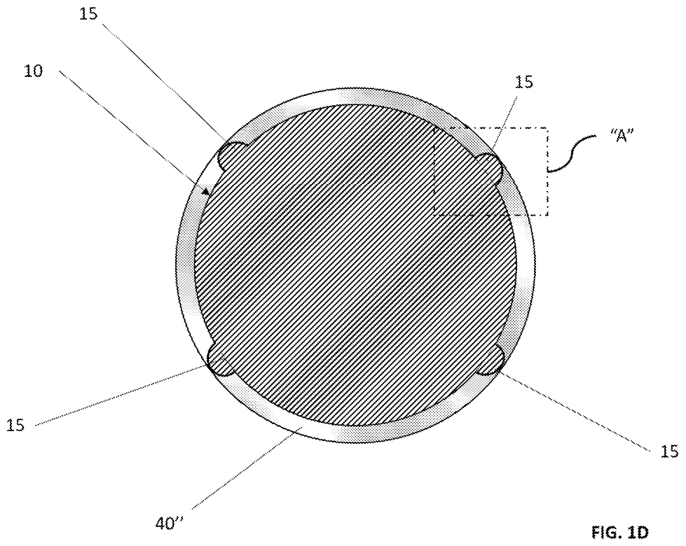

FIGS. 1A-1C illustrate various states for a molding assembly 1 in which a core body 10 can be configured to be arranged between a first casting mold 20a and a second casting mold 20b. The core body 10 has an outer surface 12 including a plurality of protrusions 15. FIG. 1A illustrates one exemplary first step in a method of forming an intermediate layer on a golf ball sub-assembly in which the material used to form the intermediate layer is deposited onto the first casting mold 20a. Next, FIG. 1B illustrates the core body 10 immediately after plunging into the first casting mold 20a. FIG. 1C illustrates a subsequent exemplary step in which the second casting mold 20b is mated with the first casting mold 20a. In one configuration, the first casting mold 20a can be a male casting mold and the second casting mold 20b can be a female casting mold. In another configuration, the first casting mold 20a can be a female casting mold and the second casting mold 20b can be a male casting mold. The first and second casting molds 20a, 20b can be heated prior to forming the intermediate layer on the golf ball sub-assembly, in one example. When using perfectly spherical core bodies (i.e., without protrusions), the golf ball sub-assembly or core body can move, migrate, or otherwise shift within the void or cavity defined by the mated casting molds if the material used to form the intermediate layer has not reached a sufficient viscosity to prevent movement of the core body within the void.

FIG. 1A illustrates one exemplary step for depositing the foamed casing material 40 onto an interior surface 22a of the casting mold 20a. A dispenser 30 can be provided for depositing the foamed casing material 40. The dispenser 30 can be formed according to any configuration sufficient to deposit a predetermined volume of the foamed casing material 40 onto the casting mold 20a. In one aspect, the dispenser 30 is configured to deposit the foamed casing material 40 directly in a center of the casting mold 20a. The dispenser 30 can be controlled by an automated control system or manually controlled. The dispenser 30 can be configured to receive a mixed compound, in one example. The dispenser 30 can include various adjustment components that can regulate the speed of mixing, temperature of the compositions being mixed, dispensing rate and volume, and other parameters. The foamed casing material is generally identified by reference numeral 40 in an initial state, reference numeral 40′ in a partially curing/expanding state, and reference numeral 40″ in a fully cured/expanded state in the Figures.

FIG. 1B illustrates the core body 10 immediately after it is plunged into the first casting mold 20a. One of ordinary skill in the art would understand that the core body 10 can be plunged either manually or automatically into the first casting mold 20a. As shown in FIG. 1B, the protrusions on the core body 10 promote centering of the core body 10 within the first casting mold 20a via direct physical contact or engagement with the interior surface 22a. While only two protrusions 15 are shown in engagement with the interior surface 22a for illustrative purposes in the Figures, one of ordinary skill in the art would understand that any number of protrusions 15 can be engaged with the interior surface 22a such that the core body 10 is stable and fully supported. In one configuration, at least ten protrusions 15 are configured to be engaged with the interior surface 22a. In another configuration, at least twenty protrusions 15 are configured to be engaged with the interior surface 22a. In another configuration, at least fifty protrusions 15 are configured to be engaged with the interior surface 22a. In yet another configuration, at least one hundred protrusions 15 are configured to be engaged with the interior surface 22a.

The core body 10 can be plunged immediately after the foamed casing material 40′ has been deposited, in one example. One of ordinary skill in the art would understand that based on the present disclosure, the core body 10 can be plunged into the first casting mold 20a prior to the foamed casing material 40 reaching a threshold viscosity. This is particularly advantageous because it reduces the complexity and precise timing requirements typically associated with plunging core bodies that lack any centering protrusions.

As shown in FIG. 1C, the core body 10 is centered within the casting molds 20a, 20b based on the protrusions 15 being engaged against interior surfaces 22a, 22b of the casting molds 20a, 20b. A void (V) is generally defined between the outer surface 12 of the core body 10 and the interior surfaces 22a, 22b of the casting molds 20a, 20b. The void (V) is configured, designed, or dimensioned to be filled in by a foamed casing material 40, 40′. The foamed casing material 40 is configured to cure and expand to fill an entirety of the void (V), such that the golf ball sub-assembly has an outer surface or layer defined by the foamed casing material 40″. As shown by the dashed arrows in FIGS. 1B and 1C, the foamed casing material 40′ generally expands around the outer surface 12 of the core body 10. One of ordinary skill in the art would understand that ventilation features, such as openings or other components can be provided on the casting molds 20a, 20b to accommodate for the expansion of the foamed casing material 40, 40′ and the air trapped within the void (V). After the foamed casing material 40′ has cured, the golf ball sub-assembly can be removed from the casting molds 20a, 20b, as shown in FIG. 1D. The golf ball sub-assembly then has a concentric intermediate layer of the foamed casing material 40″ relative to the core body 10. In one aspect, the concentricity between the core body 10 and the intermediate layer of the foamed casing material 40″ is +/−0.005 inches. Based on the protrusions 15, the outer layer formed by the foamed casing material 40″ will have a non-uniform thickness, which is shown in FIG. 1D. Based on the formation of this outer layer, one of ordinary skill in the art would understand that the hardness values in the outer layer, which includes both the protrusions 15 and the foamed casing material 40″ can be adjusted to provide varying performance characteristics. For example, a hardness of the foamed casing material 40″ can be greater than a hardness of the protrusions 15, which could provide an alternative spin profile as compared to a golf ball having an outer layer with a uniform thickness.

The core body 10 can be formed according to a variety of techniques, such as compression molding, flip molding, injection molding, retractable pin injection molding, reaction injection molding (RIM), liquid injection molding (LIM), casting, vacuum forming, powder coating, flow coating, spin coating, dipping, spraying, and other techniques. One of ordinary skill in the art would understand that any suitable formation technique can be used. In one configuration, mold cavities are provided for forming the core body 10 and each mold cavity defines a hemispherical profile as well as a plurality of protrusions 15. Two mold cavities for forming the core body 10 can be provided that are identical and symmetrical with each other. The protrusions 15 can be formed integrally with the core body 10, and therefore the protrusions 15 can be formed from the same material and techniques used to form the core body 10. In another example, the protrusions 15 can be added to the already formed core body 10. One of ordinary skill in the art would understand that various methods for providing protrusions 15 on the core body 10 can be used.

The core body 10 can be formed from a thermosetting or thermoplastic material. In one example, the core body 10 can be formed from a synthetic rubber. In some examples, the core body 10 can be formed from polybutadiene, polyisoprene, ethylene propylene rubber (EPR), ethylene-propylene-diene (EPDM) rubber, grafted EPDM rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

One of ordinary skill in the art would understand that various other types of rubber can be used, including a natural rubber and a combination of synthetic and natural rubbers. Various examples of materials for forming core bodies are disclosed in U.S. Pat. Nos. 7,429,221, 8,690,713, 9,155,938, and 8,562,461, which are each commonly assigned to Acushnet Company and which are incorporated by reference in their entirety as if fully set forth herein.

In one aspect, the protrusions 15 are formed as spherical segments, i.e., circular mounds or bumps. In one aspect, the protrusions 15 are formed as cylindrical segments, i.e., protruding rods or prongs. In another aspect, the protrusions 15 each have a uniform shape or profile. In another aspect, the shape of the protrusions 15 can vary so long as the height of the protrusions 15 is uniform and equal to or greater in length than the foamed layer.

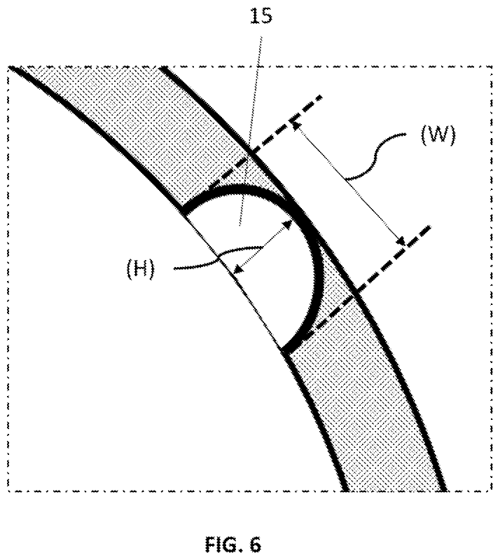

An exemplary width (W) and an exemplary height (H) of the protrusion 15 is shown in FIG. 6. The height (H) of the protrusions 15 can be 0.010 inches to 0.150 inches, preferably 0.015 inches to 0.090 inches, and more preferably 0.020 inches to 0.060 inches. The width (W) of the protrusions 15 can be 0.020 inches to 0.300 inches, preferably 0.040 inches to 0.200 inches, and more preferably 0.040 inches to 0.150 inches. In one example, the width (W) of the protrusion 15 at its base is equal to or greater than the height (H) of the protrusion 15.

One of ordinary skill in the art would understand that the profile of the protrusions can vary. The protrusions can be formed as brambles, bumps, lobes, projections, protuberances, or other raised structures. In one aspect, the protrusions can be formed as tapered conical structures. In another aspect, the protrusions can be formed as pyramid structures. In another aspect, the protrusions can be formed as a truncated conical or pyramid structure.

According to one aspect, a method of forming a golf ball sub-assembly is provided. The method comprises providing a core body comprising a plurality of protrusions that project from an outer surface of the core body. The method also comprises applying a foamed casing material to an interior surface of at least one first casting mold. The method further comprises plunging the core body into the at least one first casting mold including the foamed casing material such that at least a subset of the plurality of protrusions contacts the interior surface of the at least one first casting mold to center the core body relative to the at least one first casting mold. The method further comprises curing the foamed casing material such that the foamed casing material fills a void that is defined between the core body and the at least one first casting mold.

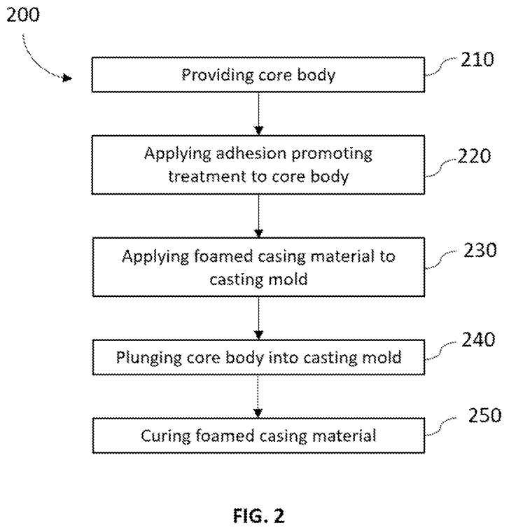

FIG. 2 illustrates exemplary steps according to a method 200. Any one or more of the steps shown in FIG. 2 can be optional or omitted. As shown in FIG. 2, step 210 includes providing a core body. Step 220 can include applying an adhesion promoting treatment to the core body. Step 220 can include, for example, applying a silane solution to the core body. Step 220 can include any other methods for improving or promoting adhesion between the core body and the foamed casing material, such as corona discharge or corona treatment, plasma treatment, application of adhesives, silane solutions, etc. A chemical-based adhesion promoting treatment can be used in place of a mechanical based adhesion promoting treatment, such as grinding, due to the presence of the protrusions on the core body. Step 230 includes applying or depositing a foamed casing material to a casting mold. Step 240 then includes plunging the core body into the casting mold. Step 250 includes curing the foamed casing material, which also includes the foamed casing material foaming or expanding to surround the entire core body.

The method can further comprise engaging the at least one first casting mold with at least one second casting mold to partially define the void (V) prior to curing the foamed casing material. The protrusions on the core body can engage against an interior surface of the second casting mold. The foamed casing material can be configured to also fill portions of the void (V) defined between the core body and the at least one second casting mold.

The method can further comprise applying the foamed casing material to an interior surface of at least one second casting mold prior to engaging the at least one first casting mold with the at least one second casting mold.

The features of the core body can vary, as one of ordinary skill in the art would appreciate based on the present disclosure. The core body can have a non-spherical profile. As used in this context, the non-spherical profile of the core body can be due to the spherical shape of the core body being interrupted or non-spherical due to the plurality of protrusions.

The core body can have a symmetrical profile. The pattern of the protrusions on the core body can be selected such that each protrusion has a corresponding matching protrusion on a diametrically opposed area of the core body.

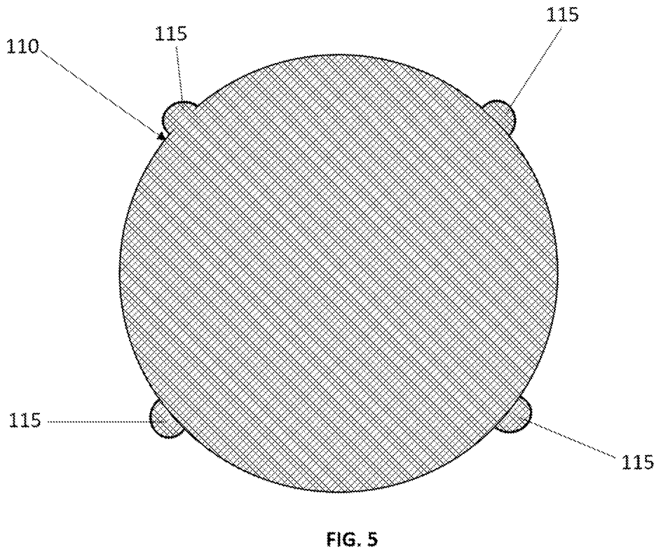

In one aspect, the core body is formed as a solid body. In another aspect, the core body has a lattice profile. One exemplary configuration is shown in FIG. 5, which shows a core body 110 for a golf ball including protrusions 115, as well as a lattice profile. The lattice structure shown in FIG. 5 is shown for illustrative purposes and the specific structure or orientation of the lattice structure can vary, as one of ordinary skill in the art would appreciate based on this disclosure. The term lattice as used in this aspect means a framework that generally defines openings, voids, cavities, or other type of space. The lattice can be formed as a regular, repeating lattice framework, or can have an irregular pattern or structure. The foamed casing material can be configured to permeate cavities of the lattice profile. As a result of the foamed casing material filling voids of the core body having a lattice profile, the overall strength and structural characteristics of the core body can be modified. Typically, a lattice profile core body would lack the durability or structure of a solid core body. Based on the foamed casing material filling the voids of the lattice, the core body with the lattice profile exhibits improved durability. The size of the pores or cavities of the lattice can be uniform or non-uniform relative to each other. The lattice of the core body can be formed from a foamed material, in one example.

One of ordinary skill in the art would appreciate from the present disclosure that the exact shape and size of the core body and the protrusions can vary. In one aspect, the outer surface of the core body has a primary outer diameter (D1) of 1.460 inches-1.590 inches. In one aspect, the core body has a secondary outer diameter (D2) in regions of the plurality of protrusions, and the secondary outer diameter (D2) is 1.510 inches-1.640 inches. The exact values for these diameters can vary, as one of ordinary skill in the art would appreciate.

The quantity, size, shape, and other characteristics of the protrusions can vary. The plurality of protrusions can cover 1%-10% of an outer surface area of the core body, in one aspect. In another aspect, the protrusions can cover less than 5% of the outer surface area of the core body. In another aspect, the protrusions can cover 5%-15% of the outer surface area of the core body.

The foamed casing material can be a polyurethane foam, in one aspect. The polyurethane foam can have a viscosity of 5,000 cp-50,000 cp when the core body is plunged. The foamed casing material is configured to expand or foam, particularly after the core body is plunged. In one example, the foamed casing material can be formed from any one or more materials or formulations disclosed in U.S. Pat. Nos. 9,694,246 and 10,124,216, which are both commonly assigned to Acushnet Company and which are both incorporated by reference in their entirety as if fully set forth herein.

The core body can be plunged in the casting mold no later than 30 seconds after step applying a foamed casing material to an interior surface of the casting mold. Plunging golf ball cores according to previously known methods typically requires waiting at least 45 seconds-90 seconds after depositing the foamed casing material. In one example according to the present disclosure, the core body can be plunged in the casting mold immediately (i.e., within 0 seconds-5 seconds) after the step of applying a foamed casing material to an interior surface of the casting mold.

Additionally, it is typically required for the foamed casing material to reach a viscosity of 50,000 cp-150,000 cp prior to plunging the core body. This is necessary to ensure that the core body is sufficiently supported away from the interior surface of the casting mold. In contrast, the present disclosure provides an arrangement in which the core body can be plunged when the foamed casing material has a viscosity of 5,000 cp-50,000 cp. In one example according to the present disclosure, the core body can be plunged when the foamed casing material has a viscosity of less than 5,000 cp.

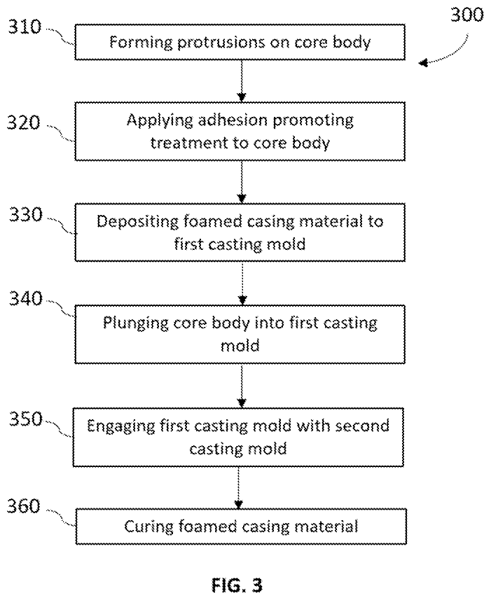

In another aspect, as shown in FIG. 3, a method 300 of forming a golf ball sub-assembly is provided that comprises forming a plurality of protrusions on a core body such that the plurality of protrusions project from an outer surface of the core body (step 310). The method 300 can further comprise applying an adhesion promoting treatment to the core body (step 320). Step 320 can be optional and can be omitted, or could include various other adhesion promoting treatments. Step 330 comprises depositing a foamed casing material to an interior surface of at least one first casting mold. The method 300 further comprises plunging the core body into the at least one first casting mold including the foamed casing material such that at least a subset of the plurality of protrusions contacts the interior surface of the at least one first casting mold to center the core body relative to the at least one first casting mold (step 340). The method 300 further comprises engaging the at least one first casting mold with at least one second casting mold to form a molding assembly that defines a void between the core body, the at least one first casting mold, and the at least one second casting mold (step 350). The void is configured or dimensioned to be filled by a foamed material. The method 300 further comprises curing the foamed casing material such that the foamed casing material expands and fills the void (step 360).

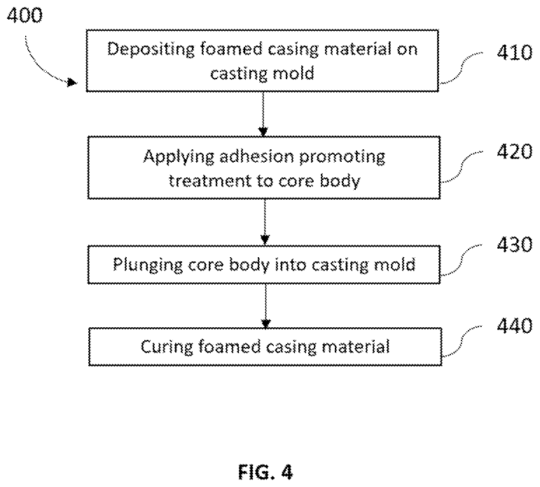

In yet another aspect, as shown in FIG. 4, a method 400 of forming a golf ball sub-assembly is provided that comprises depositing a foamed casing material on an interior surface of at least one first casting mold, wherein the foamed casing material is formed from polyurethane foam (step 410). The method 400 also comprises applying an adhesion promoting treatment to the core body (step 420). Method 400 further includes step 430 which comprises plunging the core body including plurality of protrusions into the at least one first casting mold including the foamed casing material such that at least a subset of the plurality of protrusions contacts the interior surface of the at least one first casting mold to center the core body relative to the at least one first casting mold. The at least one first casting mold can be engaged with at least one second casting mold to form a molding assembly that defines a void between the core body, the at least one first casting mold, and the at least one second casting mold. Step 430 can occur no later than 30 seconds after step 410 and while the polyurethane foam has a viscosity of 5,000 cp-50,000 cp. The method 400 can further comprise curing the foamed casing material such that the foamed casing material expands and fills the void (step 440).

Any one or more of the methods 200, 300, 400 can include depositing a foamed casing layer material within each of two casting molds, and then immediately mating the two casting molds with each other without waiting a predetermined period to allow for gelling or foaming of the foamed casing layer material. This provides a manufacturing efficiency in that the cycle time can be reduced. Additionally, the casting molds can be configured to simultaneously receive a shot of the foamed casing layer material, or can be configured to receive a shot of the foamed casing layer material within second of each other.

Once the foamed casing material is cured, a golf ball core or sub-assembly is provided that includes an underlying core body including the protrusions and an outer layer of the foamed casing material. In one aspect, an additional intermediate layer can be provided between the cover and the golf ball sub-assembly. The intermediate layer and/or the cover can be formed from ionomer resins and blends thereof (e.g., Surlyn® ionomer resins and DuPont® HPF 1000 and HPF 2000, commercially available from E. I. du Pont de Nemours and Company; Iotek® ionomers, commercially available from ExxonMobil Chemical Company; Amplify® IO ionomers of ethylene acrylic acid copolymers, commercially available from The Dow Chemical Company; and Clarix® ionomer resins, commercially available from A. Schulman Inc.); polyurethanes; polyureas; copolymers and hybrids of polyurethane and polyurea; polyethylene, including, for example, low density polyethylene, linear low density polyethylene, and high density polyethylene; polypropylene; rubber-toughened olefin polymers; acid copolymers, e.g., (meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; ethylene vinyl acetates; ethylene methyl acrylates; polyvinyl chloride resins; polyamides, amide-ester elastomers, and graft copolymers of ionomer and polyamide, including, for example, Pebax® thermoplastic polyether block amides, commercially available from Arkema Inc; crosslinked trans-polyisoprene and blends thereof; polyester-based thermoplastic elastomers, such as Hytrel®, commercially available from E. I. du Pont de Nemours and Company; polyurethane-based thermoplastic elastomers, such as Elastollan®, commercially available from BASF; synthetic or natural vulcanized rubber; and combinations thereof.

In a particular embodiment, the cover can be a single layer formed from a composition selected from the group consisting of ionomers, polyester elastomers, polyamide elastomers, and combinations of two or more thereof. The golf ball sub-assembly can be further processed to add an outer cover, such as a thermosetting material, urethane, etc. One of ordinary skill in the art would understand that additional layers can be provided for the golf ball sub-assembly.

In one aspect, viscosity modifiers can be incorporated into the foamed casing layer material. Exemplary viscosity modifiers are disclosed in U.S. Pat. No. 10,456,631, which is commonly assigned to Acushnet Company, and which is incorporated by reference in its entirety as if fully set forth herein.

One known viscosity modifier includes fumed silica, which can be configured to thicken or increase the viscosity the casing layer material. The gel time of the casing layer material can be increased via viscosity enhancers or modifiers. This material can be added to the polyurethane foam prior to depositing the casing layer material within the casting molds. Based on this modification, a first casting mold can receive a casing layer material mixture (i.e., polyurethane foam and fumed silica mixture) and a golf ball subassembly can be immediately plunged therein. A second casting mold can simultaneously receive the casing layer material mixture, and then the first and second casting molds can be immediately mated with each other. This configuration allows for the ability to immediately plunge the golf ball subassembly and then mate the casting molds with each other to form the casing layer without having to wait for a predetermined gel time or a sufficient viscosity to be reached, thereby reducing the cycle time.

In one instance, the present disclosure provides a solution in which the time window for plunging the golf ball subassembly does not depend on the curing time or the rise time of the foamed casing layer material. The golf ball subassembly can be plunged immediately after the foamed casing layer material has been dispensed or deposited within a casting mold. Furthermore, the mating casting mold which does not include the plunged golf ball subassembly can receive a shot of the foamed casing layer material and immediately be mated with the other casting mold.

According to one aspect of the present disclosure, a centering time, which is sometimes referred to as the time at which a core or other subassembly remains centered immovably in a composition within a casting mold half shell and without support, is reduced to zero. Based on the protrusions, the golf ball subassembly is immediately centered and therefore no additional time (i.e., centering time) is added to the cycle for forming the casing layer.

In another aspect, a shot of the casing layer material can be dispensed within the male and female casting molds simultaneously. The golf ball subassembly can then be immediately plunged into one of the male or female casting molds, and the other one of the male or female casting molds can then be immediately mated with the mold including the plunged golf ball subassembly. The casing layer material can include viscosity modifiers, such as fumed silica, in order to increase viscosity such that flipping at least one of the casting molds immediately after depositing the casing layer material is possible without risk of dripping or spilling of the casing layer material in an inverted casting mold.

As a result of the features disclosed herein, the present disclosure provides a non-uniform thickness foamed golf ball casing layer due to the protrusions. In one aspect, improved interlayer adhesion is provided between the core body and the foamed casing layer. This can be provided, for example, via the application of the silane bath to the core body. In another example, the lattice framework of the core body improves adhesion of the foamed casing layer and the core body.

The core body having a non-spherical profile due to the protrusions (i.e., positioning elements) ensures that the core body is centered as the foamed casing material expands or foams around the core body. As compared to known foamed layer techniques, the present disclosure avoids issues of non-concentrically arranged core bodies because the protrusions act as self-aligning or self-centering elements for the core body relative to the casting molds.

The concepts and general structural features disclosed herein can be applied to various intermediate layers or portions of the golf ball core or golf ball sub-assembly. One of ordinary skill in the art would understand that the concepts disclosed herein can improve concentricity between any intermediate layers of a golf ball sub-assembly.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

What is claimed is:

1. A method of forming a golf ball sub-assembly, the method comprising:
(i) providing a core body comprising a plurality of protrusions that project from an outer surface of the core body;
(ii) applying a foamed casing material to an interior surface of at least one first casting mold;
(iii) plunging the core body into the at least one first casting mold including the foamed casing material such that at least a subset of the plurality of protrusions contacts the interior surface of the at least one first casting mold to center the core body relative to the at least one first casting mold; and
(iv) curing the foamed casing material such that the foamed casing material fills a void defined between the core body and the at least one first casting mold, and the foamed casing material forms a casing layer around the core body.

2. The method according to claim 1, further comprising applying an adhesion promoting treatment to the core body prior to step (iii).

3. The method according to claim 2, wherein the adhesion promoting treatment comprises applying a silane solution to the core body.

4. The method according to claim 1, further comprising engaging the at least one first casting mold with at least one second casting mold to partially define the void prior to step (iv), wherein the foamed casing material is configured to also fill portions of the void defined between the core body and the at least one second casting mold.

5. The method according to claim 4, further comprising applying the foamed casing material to an interior surface of at least one second casting mold prior to engaging the at least one first casting mold with the at least one second casting mold.

6. The method according to claim 1, wherein the core body has a non-spherical profile.

7. The method according to claim 1, wherein the core body has a symmetrical profile.

8. The method according to claim 1, wherein the core body has a lattice profile, and the foamed casing material is configured to permeate cavities of the lattice profile.

9. The method according to claim 1, wherein the outer surface of the core body has a primary outer diameter of 1.460 inches-1.590 inches.

10. The method according to claim 1, wherein the core body has a secondary outer diameter in regions of the plurality of protrusions, and the secondary outer diameter is 1.510 inches-1.640 inches.

11. The method according to claim 1, wherein the plurality of protrusions cover 1%-10% of an outer surface area of the core body.

12. The method according to claim 1, wherein the plurality of protrusions cover less than 5% of an outer surface area of the core body.

13. The method according to claim 1, wherein the core body is plunged in step (iii) no later than 30 seconds after step (ii).

14. The method according to claim 1, wherein the foamed casing material is a polyurethane foam having a viscosity of 5,000 cp-50,000 cp when the core body is plunged in step (iii), and wherein the foamed casing material expands during step (iv).

15. A method of forming a golf ball sub-assembly, the method comprising:
(i) forming a plurality of protrusions on a core body such that the plurality of protrusions project from an outer surface of the core body;
(ii) depositing a foamed casing material on an interior surface of at least one first casting mold;
(iii) plunging the core body into the at least one first casting mold including the foamed casing material such that at least a subset of the plurality of protrusions contacts the interior surface of the at least one first casting mold to center the core body relative to the at least one first casting mold;
(iv) engaging the at least one first casting mold with at least one second casting mold to form a molding assembly that defines a void between the core body, the at least one first casting mold, and the at least one second casting mold; and
(v) curing the foamed casing material such that the foamed casing material expands and fills the void to form a casing layer around the core body.

16. The method according to claim 15, wherein the plurality of protrusions cover 1%-10% of an outer surface area of the core body.

17. The method according to claim 15, wherein the core body is plunged in step (iii) no later than 30 seconds after step (ii), and the foamed casing material is a polyurethane foam that has a viscosity of 5,000 cp-50,000 cp while the core body is plunged in step (iii).

18. The method according to claim 15, further comprising applying an adhesion promoting treatment to the core body prior to plunging in step (iii).

19. The method according to claim 15, wherein the core body has a lattice profile, and the foamed casing material is configured to permeate cavities of the lattice profile.

20. A method of forming a golf ball sub-assembly, the method comprising:
(i) depositing a foamed casing material on an interior surface of at least one first casting mold, wherein the foamed casing material is formed from polyurethane foam;
(ii) plunging a core body including plurality of protrusions into the at least one first casting mold including the foamed casing material such that at least a subset of the plurality of protrusions contacts the interior surface of the at least one first casting mold to center the core body relative to the at least one first casting mold,
wherein plunging the core body occurs no later than 30 seconds after step (i) and while the polyurethane foam has a viscosity of 5,000 cp-50,000 cp;
(iii) engaging the at least one first casting mold with at least one second casting mold to form a molding assembly that defines a void between the core body, the at least one first casting mold, and the at least one second casting mold; and
(iv) curing the foamed casing material such that the foamed casing material expands and fills the void to form a casing layer around the core body.
